(19) United States
(12) Patent Application Publication
(10) Pub. No.: US 2023/0058234 A1
(43) Pub. Date: Feb. 23, 2023

(54) DETERMINING LOCATION INFORMATION USING CYCLOSPECTRAL DETECTION

(71) Applicant: Michael Charles Kleder, Ashburn, VA (US)

(72) Inventor: Michael Charles Kleder, Ashburn, VA (US)

(21) Appl. No.: 17/713,668

(22) Filed: Apr. 5, 2022

Related U.S. Application Data
(60) Provisional application No. 63/170,909, filed on Apr. 5, 2021.

(51) Int. Cl. G01S 1/08; G01S 3/52

(52) U.S. Cl. CPC G01S 1/08; G01S 3/52

(57) ABSTRACT

A method is disclosed to receive a signal, in a receiver from a transmitter (e.g., over a period of time). The signal propagates from the transmitter to the receiver in a direction of propagation. The receiver may move in a direction of motion relative to the transmitter. The signal includes a cyclic feature. The method may determine a change rate of a Doppler shift of the cyclic feature in the received signal. The method may determine, based on the change rate of the Doppler shift of the cyclic feature, an angle between the direction of motion of the receiver and the direction of propagation, the range between the receiver and the transmitter, and/or the locations of the transmitter and/or receiver.

### RELATED APPLICATIONS

This patent application is based on and claims priority to U.S. Provisional Patent Application No. 63/170,909, filed Apr. 5, 2021, which is incorporated by reference herein.

### BACKGROUND

It is often useful to determine the location of an object or device that is emitting, transmitting, or generating a signal. A signal is a vibration of matter or energy that emanates from a source. In the case of a radar or broadcast tower, the signal may transmit information. The object that is the source of the signal is an emitter or transmitter, and the object that observes the signal is the detector or receiver.

### SUMMARY

A method may include receiving a signal, in a receiver from a transmitter (e.g., over a period of time). The signal propagates from the transmitter to the receiver in a direction of propagation, the receiver may move in a direction of motion relative to the transmitter, and the signal may include a cyclic feature. The method may include determining a change rate of a Doppler shift of the cyclic feature in the received signal, and determining, based on the change rate of the Doppler shift of the cyclic feature, an angle between the direction of motion of the receiver and the direction of propagation.

The method may include determining a closing acceleration between the transmitter and the receiver. Determining the angle may include determining the angle based on the closing acceleration. The method may include determining a rate of change of the angle between the direction of motion of the receiver and the direction of propagation. The method may include determining a range from the receiver to the transmitter based on the rate of change of the angle. Determining the change rate of the Doppler shift of the cyclic feature in the received signal may include determining a cyclic power spectral density of the received signal.

The period of time may be a first period of time, the direction of propagation may be a first direction of propagation, the change rate of a Doppler shift may be a first change rate of the Doppler shift, and the angle may be a first angle The method may include receiving the signal, in the receiver from the transmitter (e.g., over a second period of time). The signal may propagate from the transmitter to the receiver in a second direction of propagation. The method may include determining a second change rate of a Doppler shift of the cyclic feature in the received signal; and determining, based on the second change rate of the Doppler shift, a second angle between a second direction of motion of the receiver and the direction of propagation.

A device may include a receiver to receive a signal from a transmitter (e.g., over a period of time). The signal propagates from the transmitter to the receiver in a direction of propagation. The receiver is moving in a direction of motion relative to the transmitter and the signal includes a cyclic feature. The device may include a processor configured to determine a change rate of a Doppler shift of the cyclic feature in the received signal and determine, based on the change rate of the Doppler shift of the cyclic feature, an angle between the direction of motion of the receiver and the direction of propagation.

The processor may be configured to determine a closing acceleration between the transmitter and the receiver. The processor may be configured to determine the angle based on the closing acceleration. The processor may be configured to determine a rate of change of the angle between the direction of motion of the receiver and the direction of propagation. The processor may be configured to determine a range from the receiver to the transmitter based on the rate of change of the angle. The processor may be configured to determine a cyclic power spectral density of the received signal when determining the change rate of the Doppler shift of the cyclic feature in the received signal.

The period of time may be a first period of time, the direction of propagation may be a first direction of propagation, the change rate of a Doppler shift may be a first change rate of the Doppler shift, and the angle may be a first angle, the receiver may be configured to receive the signal from the transmitter (e.g., over a second period of time), and the signal may propagate from the transmitter to the receiver in a second direction of propagation. The processor may be further configured to determine a second change rate of a Doppler shift of the cyclic feature in the received signal and determine, based on the second change rate of the Doppler shift, a second angle between a second direction of motion of the receiver and the direction of propagation.

A non-transitory computer-readable storage medium may include computer program code that, when executed by one or more processors, causes the one or more processors to perform operations. The computer program code may include instructions to receive data indicative of a signal having been received from a transmitter (e.g., over a period of time). The signal may propagate from the transmitter to the receiver in a direction of propagation. The receiver may move in a direction of motion relative to the transmitter, and the signal may include a cyclic feature. The instructions may cause the processor to determine a change rate of a Doppler shift of the cyclic feature in the signal. The instructions may cause the processor to determine, based on the change rate of the Doppler shift of the cyclic feature, an angle between the direction of motion of the receiver and the direction of propagation.

The instructions may include instructions to determine a closing acceleration between the transmitter and the receiver. The instructions may include instructions to determine the angle based on the closing acceleration. The instructions may include instructions to determine a rate of change of the angle between the direction of motion of the receiver and the direction of propagation.

The instructions may include instructions to determine a range from the receiver to the transmitter based on the rate of change of the angle. The instructions to determine the change rate of the Doppler shift of the cyclic feature in the received signal may include instructions to determine a cyclic power spectral density of the received signal. The period of time may be a first period of time, the direction of propagation may be a first direction of propagation, and the change rate of a Doppler shift may be a first change rate of the Doppler shift, and the angle may be a first angle. The computer program code may include instructions to receive the signal, in the receiver from the transmitter (e.g., over a second period of time), where the signal propagates from the transmitter to the receiver in a second direction of propagation. The instructions may include instructions to determine a second change rate of a Doppler shift of the cyclic feature in the received signal, and determine, based on the second change rate of the Doppler shift, a second angle between a second direction of motion of the receiver and the direction of propagation.

### DESCRIPTION OF THE DRAWINGS

FIG. 1A is a diagram of an environment in which methods and systems described herein may be implemented;

FIG. 1B is a diagram of the environment of FIG. 1A showing directions and angles;

FIG. 2A is a block diagram of exemplary components in a computing module;

FIG. 2B is a block diagram of exemplary receiver server in an embodiment;

FIG. 3A is a plot of cyclic power spectral density as a three-dimensional graph;

FIG. 3B is a plot of cyclic power spectral density as a two-dimensional graph; and

FIG. 4 is a flowchart of a process for determining location information using cyclospectral detection.

### DETAILED DESCRIPTION

Human-made signals often include repetitive features, i.e., aspects of the signal which happen repeatedly in time. Each repetitive feature may generally repeat over fixed intervals of time, in which case the repetitive feature is called a cyclic feature. Natural background noise generally does not have cyclic features. Cyclospectral processing or cyclospectral detection may be used to find the repetition rates of cyclic features in a received signal. Because natural background noise generally does not contain cyclic features, cyclospectral detection may be used to help discriminate between human-made signals and natural background noise. Cyclospectral detection may enable this discrimination better than other techniques of doing so.

Methods and systems described herein may employ a detector (e.g., a cyclospectral detector) to detect features in a signal emanating from an emitter and received in the detector, including the frequency (e.g., rate of occurrence) of those features. The detector may also determine a rate of change of the occurrence of those features. In some situations, the detector may be moving relative to the emitter. In this situation, the frequency of the features may shift (e.g., change) due to the Doppler effect and, in one embodiment, the detector may determine the rate of change in the Doppler shift of the features. In one embodiment, the Dopper shift change rate may be used to determine location information.

In one embodiment, the rate of change of the Doppler shift may be used to compute the closing acceleration of a detector relative to an emitter and/or the angle (e.g., azimuth) from the detector to the emitter. The time rate of change in that azimuth from the detector to the emitter may be used to compute the range or distance from the detector to the emitter. Additional measurements (e.g., of the Doppler shift change rate) may yield results which are filtered (e.g., statistically) for an increasingly precise result. Ambiguities (e.g., multiple solutions) to these determinations (such as multiple solutions of azimuth and/or range) may be resolved with additional measurements, such as when the relative motion between the emitter and detector is changed, for example, by changing the direction of the motion of the detector (e.g., relative to each other).

In one embodiment, methods and systems described may determine the location (e.g., location information) of an emitter using two detectors. In another embodiment, location of the emitter may be determined using only one detector. In some implementations, methods and systems described may provide for greater precision and sensitivity to determine location than the state of the art. In one or more embodiments, the method may use cyclospectral detection and/or relative Doppler change rates (e.g., rather than or in addition to Doppler shift alone). In some implementations, determinations (e.g., of azimuth and/or range) may be computed in closed form rather than by iterative calculation method. In some instances, closed form solutions may provide for more rapid calculations than iterative methods.

The frequency of a signal is the rate at which the signal vibrates with respect to time. The frequency with which the emitter creates the signal is called the emitted frequency, and the frequency of the signal that the detector detects is called the detected frequency. The rate at which a signal moves outward from the emitter is called the signal speed. The signal speed depends on the medium through which the signal is traveling rather than the motion of either the emitter or the detector. In one embodiment, the signal speed may be approximated as a constant quantity. In another embodiment, the signal speed may be approximated by considering the change in the medium, such as atmospheric conditions.

The motion of an object at any instant may be described by the speed and the direction of motion. Together, these form a vector called the velocity of the object. When either the emitter or the detector, or both, are in motion relative to each other, a phenomenon called a Doppler shift changes the frequency of vibration that the detector detects. That is, the detected frequency shifts. When the distance between the emitter and the detector is decreasing, the detected frequency is higher than the emitted frequency, which is called a positive Doppler shift. When the distance between the emitter and the detector is increasing, the detected frequency is lower than the emitted frequency, which is called a negative Doppler shift. In either case, the rate at which the distance between the emitter and detector is changing determines the magnitude of the Doppler shift. Thus, the Doppler shift is a number which can take any positive or negative value.

The emitted frequency may be called the true emitter frequency, and the observed frequency may be called the apparent frequency or the apparent emitter frequency. The Doppler shift can be expressed as a frequency change in units of Hertz, which may be called the absolute Doppler shift. One Hertz is defined as one oscillation per second. The Doppler shift can alternatively be expressed as a fractional change between the emitted and detected frequencies, which is a unitless number called the relative Doppler shift. The relative Doppler shift is the difference between the detected frequency and the emitted frequency divided by the emitted frequency (i.e., the detected frequency minus the emitted frequency, followed by the division of the result by the emitted frequency). Thus, the emitted frequency may be expressed as the detected frequency divided by a quantity equal to the sum of the relative Doppler shift and the quantity one.

If either the emitter or the detector is stationary, then the motion of the other determines the sign and magnitude of the Doppler shift observed by the detector. The location of every object (e.g., emitter or detector) is stationary relative to itself, so without loss of generality a perspective from either object as stationary may be assumed. With this perspective, the motion of the other object, relative to the stationary object, is called the relative motion of the other object, or the relative motion of the two objects. The perspective of any person or object in a coordinate system in which the location of that object is stationary is called the reference frame of that (stationary) object.

The rate at which the distance between the emitter and detector is decreasing is called the closing speed, which may be positive or negative. The direction and magnitude, together, of the rate at which the distance between the emitter and detector is decreasing is a vector called the closing velocity. The term closing velocity may be used to refer to the closing speed, or to the magnitude of the closing velocity, in which case the intended meaning is determined by the context. The closing velocity may describe direction and speed at any instant.

When the signal speed is known, the closing speed may determine (e.g., may uniquely determine) the relative Doppler shift. Likewise, the relative Doppler shift may determine (e.g., may uniquely determine) the closing speed. The relationship (called the Doppler effect) is that the closing speed may be expressed as the signal speed multiplied by the relative Doppler shift.

As noted, human-made signals may include one or more repetitive or cyclic features, i.e., aspects of the signal which happen repeatedly in time. Cyclospectral processing or cyclospectral detection may be used to find the repetition rates of cyclic features in a signal. In one embodiment, cyclospectral detection may be performed on a signal by performing a cyclic autocorrelation, followed by a two-dimensional Fourier transform, followed by a squared-norm (i.e., multiplication by the complex conjugate). In one implementation, a digital computer may perform these calculations using fast Fourier transform (FFT) software. These may also be performed in signal processing hardware (or a combination of hardware and software) designed for the purpose.

Methods and systems described herein may employ a cyclospectral detector to detect features in a signal emitted from an emitter and received in the detector. In one embodiment, the detector may determine a rate of occurrence of features in the signal and/or a Doppler shift change rate of features in a signal. In one embodiment, the Doppler shift change rate may be used to compute the closing acceleration of the detector relative to an emitter and/or the azimuth from the detector to the emitter. In one embodiment, the time rate of change in the azimuth from the detector to the emitter may be used to compute the range from the detector to the emitter. Additional measurements yield results which are filtered (e.g., statistically) for an increasingly precise result. Ambiguities (e.g., multiple solutions) to these determinations (such as multiple solutions of azimuth, elevation, and/or range) may be resolved with additional measurements, in particular when the relative motion between the emitter and detector is changed, for example, by a direction change of the motion of the detector and/or by a direction change in the motion of the emitter.

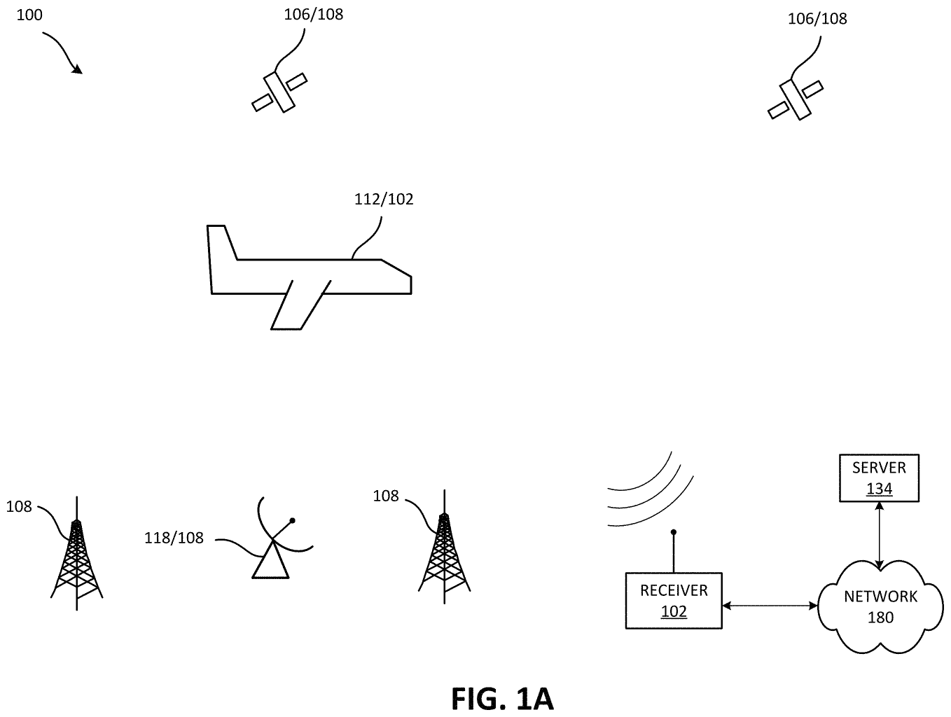

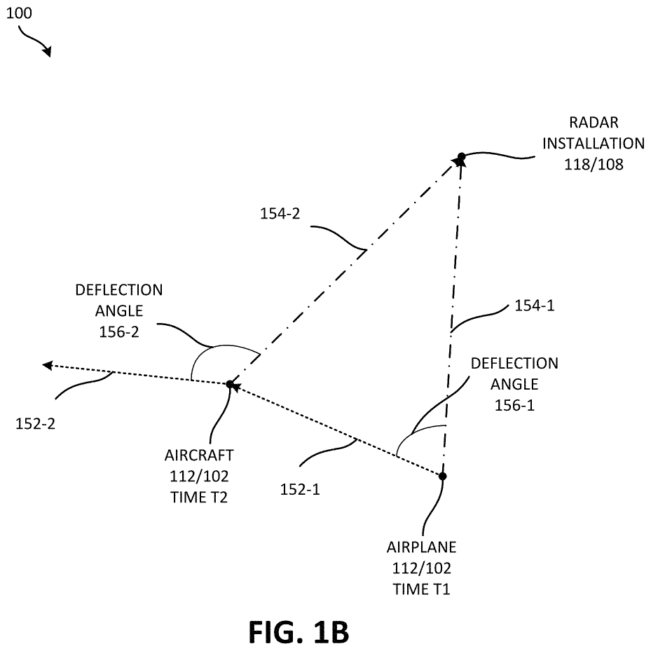

FIG. 1A depicts an exemplary environment 100 for implementing algorithms disclosed herein. Environment 100 includes one or more receivers 102 (referred to individually as receiver 102), satellites 106 (individually referred to as satellite 106), one or more transmitters 108 (individually referred to as transmitter 108), an aircraft 112, a server 134, a radar installation 118, and/or a network 180.

Transmitter 108 may include any type of transmitter that transmits or emits a signal that is received by receiver 102. Transmitter 108 may transmit or emit human-made signals that include periodically repeating portions called cyclic features. Signals created by human-made devices may include one or more cyclic features. Cyclic features can appear at one, some, or all of the various frequencies of vibration that are contained within a signal. Each cyclic feature can have its own frequency of repetition, which can be different from the frequency or frequencies of the signal in which the feature appears.

Transmitters 108 may include radar installations 118, satellites 106, hand-held radios, mobile telephones, terrestrial broadcast antennas, and/or terrestrial mobile telephone towers. Transmitter 108 may have a fixed location. Alternatively, transmitter 108 may be moving (e.g., relative to the surface of the earth). If a television broadcast antenna, for example, transmitter 108 may transmit television signals using the Advanced Television System Committee (ATSC) standard. In one embodiment, the location of transmitter 108 is known (to some degree) with respect to time. For example, transmitter 108 may be fixed with time relative to the surface of the earth (such as a TV broadcast tower). Alternatively, transmitter 108 may move with time relative to the surface of the earth (such as with satellite 106). In one implementation, transmitter 108 may transmit sound waves that may include human-made cyclic features instead of or in addition to electromagnetic waves. As such, transmitter 108 may additionally or alternatively be coupled to a speaker as well as an antenna.

Receiver 102 may receive signals from transmitter 108 and record the signal to memory (e.g., sample and quantize) for signal processing. In one implementation, receiver 102 may, in addition to or as an alternative to receiving electromagnetic signals, receive sound waves. As such, receiver 102 may include a microphone in addition to or alternative to an antenna. Aircraft 112 may include receiver 102, for example.

Satellites 106 may be placed in varying orbits and may themselves include transmitter 108 from which receivers 102 may receive signals. Satellites 106 may include satellites in a global navigation satellite system (GNSS) for determining locations of devices (e.g., locations of receivers 102) relative to the surface of the earth (e.g., in coordinates such as latitude and/or longitude). Satellites 106 may include GPS (Global Positioning System) satellites, GLONASS (Globalnaya Navigatsionnaya Sputnikovaya Sistema) satellites, Galileo satellites, BeiDou satellites, or any combination of these satellites or other navigation satellites. In one embodiment, methods and systems disclosed herein may be used to improve the location determined by GNSS. In one embodiment, satellite 106 may include receivers 102.

Aircraft 112 may include any moving platform that carries receiver 102. In one embodiment, aircraft 112 may include an airplane, a helicopter, and/or a drone that moves relative to the earth. In other embodiments, aircraft 112 may be any moving platform such as an automobile or a train.

Server 134 may provide services to receiver 102 and/or process signals recorded by receiver 102 as described herein. In one embodiment server 134 may determine or contribute to the determination of location (e.g., location information) of receiver 102 and/or transmitter 108. In another embodiment, server 134 is not present and/or is incorporated into receiver 102 that provides the services of determining or contributing to the determination of location of receiver 102 and/or transmitter 108.

Network 180 may allow any device (e.g., receiver 102) in environment 100 to communicate with any other device (e.g., server 134) in environment 100. Network 180 may include one or more packet switched networks, such as an Internet protocol (IP) based network, a local area network (LAN), a wide area network (WAN), an intranet, the Internet, a cellular network, a fiber-optic network, or another type of network that is capable of transporting data. Network 180 may communicate wirelessly with receiver 102 and/or server 134 using any number of protocols, such as GSM (Global System for Mobile Communications), CDMA (Code-Division Multiple Access), LTE (Long-Term Evolution), WiFi (e.g., IEEE 802.11x) or WiMAX (e.g., IEEE 802.16x), etc.

Devices in environment 100 may use network 180 such that, for example, any one device may receive signals and/or messages from any other device. Further devices in environment 100 may be networked together such that, for example, any one device may transmit signals and/or messages to any other device. In one implementation, receiver 102 may receive signals from one or more transmitters 108 without necessarily transmitting signals to any transmitter 108.

FIG. 1B is a diagram of exemplary directions and angles of movement of objects (e.g., receiver 102 and/or transmitter 108) in environment 100. As shown in FIG. 1B, environment 100 includes radar installation 118 (having transmitter 108) and aircraft 112 (carrying receiver 102). FIG. 1B shows aircraft 112 at two different times (e.g., time T1 and time T2).

As shown, aircraft 112 is flying in the direction of arrow 152-1 at a time T1. The direction from aircraft 112 to radar installation 118 at time T1 is indicated by arrow 154-1. Arrow 154-1 also indicates the line-of-sight from aircraft 112 to radar installation 118 or the (reverse of the) direction of propagation of the signal from radar installation 118 to aircraft 112. At time T1, the angle between the direction of motion of aircraft 112 and the direction from aircraft 112 to radar installation 118 is the deflection angle 156-1 (referred to generally as deflection angle 156).

At time T2, aircraft 112 is flying in the direction of arrow 152-2. The direction from aircraft 112 to radar installation 118 at time T2 is indicated by arrow 154-2. At time T2, the angle between the direction of motion of aircraft 112 and the direction from aircraft 112 to radar installation 118 is the deflection angle 156-2. At time T2, both the deflection angle 156 and the range from aircraft 112 to radar installation 118 is different from at time T1.

The exemplary configurations of devices in environment 100 of FIG. 1A and FIG. 1B are illustrated for simplicity. In particular, the configuration of devices in environment 100 shown in FIG. 1B is used as an example below. Environment 100 may include more devices, fewer devices, or a different configuration of devices than illustrated. For example, environment 100 may include additional or fewer transmitters 108, additional or fewer satellites 106, etc. As another example, environment 100 may include hundreds, thousands, or millions of receivers and/or servers. Environment 100 may include sonar in addition to or as an alternative to radar installation 118. In some embodiments, the functions performed by two or more devices may be performed by any one device. Likewise, in some embodiments, the functions performed by any one device may be performed by any other device or multiple devices. As noted, environment 100 may not include server 134 or server 134 may be incorporated into the receiver 102.

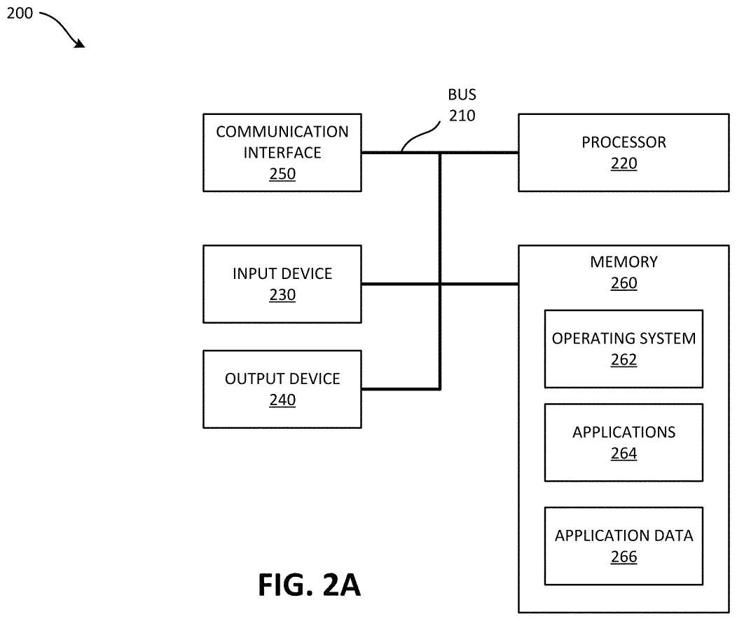

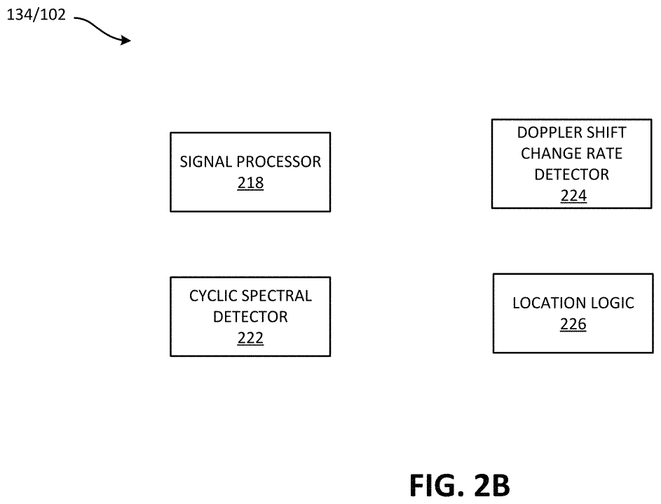

Devices in environment 100 may each include one or more computing modules. FIG. 2A is a block diagram of exemplary components in a computing module 200. Computing module 200 may include a bus 210, processor 220, an input device 230, an output device 240, a communication interface 250, and a memory 260. Computing module 200 may include other components (not shown) that aid in receiving, transmitting, and/or processing data. Moreover, other configurations of components in computing module 200 are possible.

Bus 210 includes a path that permits communication among the components of computing module 200. Processor 220 may include any type of processor or microprocessor (or families of processors, microprocessors, or signal processors) that interprets and executes instructions. In other embodiments, processor 220 may include an application-specific integrated circuit (ASIC), a field-programmable gate array (FPGA), etc.

Communication interface 250 may include a transmitter and/or receiver (e.g., a transceiver) that enables computing module 200 to communicate with other devices or systems. Communication interface 250 may include a transmitter that converts baseband signals (e.g., non-modulated signals) to radio frequency (RF) signals or a receiver that converts RF signals to baseband signals. Communication interface 250 may be coupled to one or more antennas for transmitting and receiving electromagnetic (e.g., RF) signals. Communication interface 250 may be coupled to a microphone and/or a speaker for transmitting and receiving acoustic (e.g., sound) signals.

Communication interface 250 may include a network interface card, e.g., Ethernet card, for wired communications or a wireless network interface (e.g., a WiFi) card for wireless communications. Communication interface 250 may also include, for example, a universal serial bus (USB) port for communications over a cable, a Bluetooth wireless interface, a radiofrequency identification (RFID) interface, a near-field communications (NFC) wireless interface, etc. Communication interface 250 may be adapted to receive signals from transmitter 108, satellites 106 (e.g., GNSS satellites), or other transmitters (e.g., cell towers, radio towers, etc.). Communication interface 250 may allow communication using standards, such as GSM, CDMA, LTE, WiFi, or WiMAX.

Memory 260 may store information describing signals received from communication interface 250. For example, a signal may propagate through space, be received by an antenna (or microphone), be sampled, quantized, and/or stored in memory 260 for analysis by signal processor 218. In addition, memory 260 may store information and instructions (e.g., applications 264 and operating system 262) and data (e.g., application data 266) for use by processor 220. Memory 260 may include a random access memory (RAM) or another type of dynamic storage device, a read-only memory (ROM) device or another type of static storage device, and/or some other type of magnetic or optical recording medium and its corresponding drive (e.g., a hard disk drive).

Operating system 262 may include software instructions for managing hardware and software resources of computing module 200. For example, operating system 262 may include GNU/Linux, Windows, OS X, Android, iOS, an embedded operating system, etc. Applications 264 and application data 266 may provide network services or include applications, depending on the device in which the particular computing module 200 is found.

Input device 230 may allow a user to input information into computing module 200. Input device 230 may include a keyboard, a mouse, a microphone, a camera, a touch-screen display, etc. Some devices may not include input device 230. In other words, some devices (e.g., a “headless” device such as server 134) may be remotely managed through communication interface 250 and may not include a keyboard, for example.

Output device 240 may output information to the user. Output device 240 may include a display, a display panel, light-emitting diodes (LEDs), a printer, a speaker, etc. Headless devices, such as server 134, may be autonomous, may be managed remotely, and may not include output device 240 such as a display, for example.

Input device 230 and output device 240 may allow a user to activate and interact with a particular service or application. Input device 230 and output device 240 may allow a user to receive and view a menu of options and select from the menu options. The menu may allow the user to select various functions or services associated with applications executed by computing module 200.

Computing module 200 may include more or fewer components than shown in FIG. 2A. For example, computing module 200 may include a speedometer, a magnetometer, an accelerometer, a compass, a gyroscope, etc. The functions described as performed by any component may be performed by any other component or multiple components. Further, the functions performed by two or more components may be performed by a single component.

Computing module 200 may perform the operations described herein in response to processor 220 executing software instructions contained in a tangible, non-transient computer-readable medium, such as memory 260. A computer-readable medium may include a physical or logical memory device. The software instructions may be read into memory 260 from another computer-readable medium or from another device via communication interface 250. The software instructions contained in memory 260 may cause processor 220 to perform processes that are described herein.

As described herein, methods and systems described may determine location information related to emitters (e.g., transmitter 108) in environment 100 (e.g., relative to receiver 102). In one embodiment, signals may be received and observations recorded. For example, in one embodiment, the location of receiver 102 (e.g., as determined by location logic 226 or some other method) and/or the time (e.g., as determined by a clock or another means) may be recorded. For example, aircraft 112 may carry receiver 102 through environment 100 while receiving signals that are transmitted from transmitter 108. Recording the observations (e.g., information about the signals) may include recording into memory 260 information indicative of the power level or other features (e.g., SNR, phase, frequency, polarization, etc.) of the received signal and the corresponding time. In addition, the location (e.g., determined by location logic 226 or some other method) of receiver 102 may be recorded in memory 260 and associated with the observation. In one embodiment, the time the signals (e.g., determined by a clock or other means) are received and observed may also be recorded in memory 260 and associated with the corresponding signal information. Recorded observations may also be referred to as measurements or measured observations.

Receiver 102 may receive signals and record observations periodically (e.g., based on time such as every fraction of a second, every second, every few seconds, every minute, every few minutes, etc.) or aperiodically (e.g., not evenly spaced in time). Receiver 102 may receive signals and record observations at particular distance intervals (e.g., every few feet, every meter, every kilometer, etc.) or aperiodic distance intervals (e.g., distances not evenly spaced). Receiver 102 may receive signals and record observations when in a particular location. In another embodiment, multiple different receivers 102 may receive signals and record observations. In this embodiment, receivers 102 may be in different locations and the corresponding locations may then be recorded in memory 260 and associated with the recorded observations.

FIG. 2B is a block diagram of exemplary components (e.g., functional components) of receiver 102 and/or server 134 in one embodiment. Receiver 102 and/or server 134 may include a signal processor 218, a cyclic spectral detector 222, a Doppler shift change rate (DSCR) detector 224, and location logic 226. Receiver 102 and/or server 134 may include additional, fewer, or a different arrangement of components than shown in FIG. 2B. Further, in other embodiments, any component may perform the functions described below of any other component.

Signal processor 218 may process received signals and/or process observations recorded regarding received signals. In one embodiment, signal processor 218 employs cyclic spectral detector 222, DSCR detector 224, and/or location logic 226. Signal processor 218 may be coupled to an antenna (or microphone) and include a demodulator, a sampler, and/or a mixer.

Cyclic spectral detector 222 may determine the amplitude or power of each cyclic feature that exists at different frequencies of a signal. Cyclic spectral detector 222 may perform first or higher orders of cyclospectral detection.

DSCR detector 224 may determine the Doppler shift change rate of received signals based on information determined by cyclic spectral detector 222. As noted above, the detected frequency of a received signal (or features therein) may have been shifted relative to the emitted frequency, and the shift may change with time. The time rate of change in the relative Doppler shift is called the relative Doppler shift change rate and has units of inverse seconds. The Dopper shift change rate may be based on the change of the rate of the features in the signal (e.g., features as determined by the cyclic spectral detector 222).

In one embodiment, DSCR detector 224 may apply a reversal to the Doppler shift change rate on the received signal that has been detected and recorded, in an attempt to determine or recover the emitted signal (e.g., without the Doppler shift change rate). That is, when the Doppler shift change rate is the true rate (e.g., the rate to which the signal was actually subjected) the cyclic features will have their timing returned to a constant cyclic feature repetition rate. In one embodiment, DSCR detector 224 may search for the Doppler shift change rate which maximizes the cyclic feature power density to determine the true Doppler shift change rate to which the emitted signal was actually subjected. DSCR detector 224 may maximize either the maximum of, or the integral of, or the average of, or the mean square of the cyclic feature power density, or any other quantity which would tend to indicate a higher value of some or all of the cyclic feature power density. DSCR detector 224 may search for the true Doppler shift change rate using optimization techniques such as a Nelder-Mead search, a Newton's Method search, a randomized hill-climbing search, a genetic algorithm, or any other optimization or searching technique.

Location logic 226 may use information from cyclic spectral detector 222 and/or DSCR detector 224 to determine location information. The location information may help determine the location of receiver 102 and/or transmitter 108 relative to each other and/or relative to the earth. The location information may include an azimuth angle and/or range, for example. The location information may also include an elevation angle.

In one embodiment, location logic 226 may include GNSS logic to determine the location of transmitter 108 and/or receiver 102 relative to the surface of the earth (e.g., latitude and/or longitude) and/or location information of receiver 102 relative to satellites 106. Location logic 226 may then use methods and systems disclosed herein to improve the location determined by GNSS logic or use the location to determine the location of transmitter 108 relative to the surface of the earth. GNSS logic may interpret signals received from satellites 108 to derive location information. GNSS logic may include logic that interprets signals from GPS (Global Positioning System) satellites, GLONASS (Globalnaya Navigatsionnaya Sputnikovaya Sistema) satellites, Galileo satellites, BeiDou satellites, or any combination of these satellites or other navigation satellites.

Location logic 226 may determine the closing acceleration from receiver 102 to transmitter 108 and/or the angle of deflection from receiver 102 to transmitter 108 (e.g., at multiple times). For an emitter that is stationary in its own reference frame, and a detector in relative motion that is therefore moving in the reference frame of the emitter, the closing acceleration is the time rate of change in the closing speed. The angle between the direction of motion of the detector and the direction from the detector to the emitter is called the angle of deflection to the emitter, which can be defined in either two-dimensional or three-dimensional space. In two-dimensional space, the angle of deflection to the emitter may be referred to as the azimuth to the emitter. In three-dimensional space, the angle of deflection to the emitter may be expressed as the azimuth and elevation to the emitter.

In one embodiment, location logic 226 may determine the rate of change in the closing speed by multiplying the signal speed by the relative Doppler shift change rate. That is, location logic 226 may determine the closing acceleration based on the signal speed and the relative Dopper shift change rate.

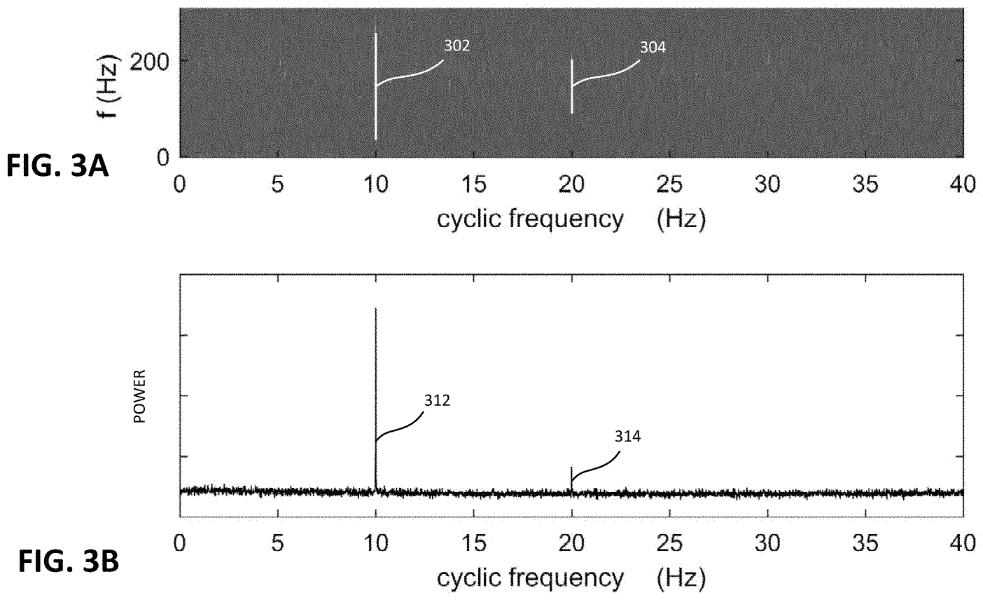

FIG. 3A is a plot of cyclic power spectral density of an illustrative emitted signal (e.g., from transmitter 108) as a three-dimensional graph. In FIG. 3A, the horizontal axis shows the frequency of repetition of each cyclic feature (e.g., 0 Hz to 40 Hz). The vertical axis shows the signal frequency within which each cyclic feature exists (e.g., 0 to 250 Hz). The third axis (e.g., the intensity of the plot) shows the power of each cyclic feature at each signal frequency (e.g., where white is high intensity and block is low intensity). As shown in FIG. 3A, there are a number of features that repeat at 10 Hz that are carried on signal frequencies of approximately 50 to 200 Hz. Because of the number of features that repeat at 10 Hz, the power of the features appear as a white line 302 (e.g., the power is distributed over carrier frequencies of 50 to 250 Hz at 10 Hz cyclic feature frequency). In addition, there are a number of features that repeat at 20 Hz that are carried on signal frequencies of approximately 100 to 250 Hz. Because of the number of features that repeat at 20 Hz, the power of the features appear as a white line 304 (e.g., the power is distributed over carrier frequencies of 100 to 200 Hz at 20 Hz cyclic feature frequency). At receiver 102, in the presence of a constant closing velocity between transmitter 108 and receiver 102, the detected power spectral density would be such that line 302 would appear to have shifted left or right by a fixed amount proportional to the closing velocity. In the presence of a closing acceleration, on the other hand, line 302 would appear to move steadily with time in one direction or the other, the magnitude of the motion of the line 302 being proportional to the closing acceleration.

FIG. 3B is a plot of cyclic power spectral density of an illustrative emitted signal (e.g., from transmitter 108) as a two-dimensional graph. In FIG. 3B, the horizontal axis shows the cycle repetition frequency and the vertical axis shows the power attained by the cyclic features (e.g., all the cyclic features) at each cyclic repetition frequency (e.g., no matter where they exist in the signal frequency band). As an example, the three-dimensional plot of FIG. 3A is shown as a two-dimensional plot in FIG. 3B. As shown in FIG. 3B, all the cyclic features that repeat at 10 Hz have a high power (line 312) relative to all the power (line 314) of the cyclic features that repeat at 20 Hz. At receiver 102, the detected power spectral density would appear as described above with respect to three-dimensional power spectral density.

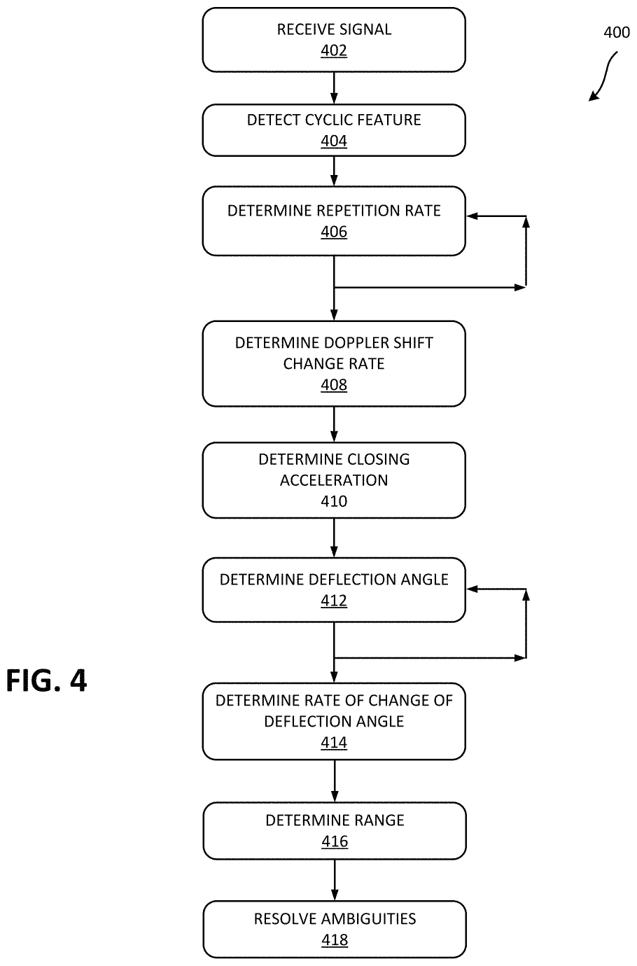

As described herein, methods and systems may use cyclospectral detection to determine location information. FIG. 4 is a flowchart of a process 400 for determining location information using cyclospectral detection. Process 400 may be executed by receiver 102, server 134, and/or other devices. Process 400 is described with respect to FIG. 1A and FIG. 1B, which illustrates environment 100 with transmitter 108 and receiver 102.

For ease of understanding, process 400 is described with respect to the reference frame of transmitter 108. That is, transmitter 108 is described as stationary and receiver 102 is described as in motion relative to transmitter 108. This model is for convenience and is not a limitation, since the laws of physics are unchanged in any inertial reference frame, and solutions in this reference frame apply equally well to solutions in any other inertial reference frame with appropriate modifications. Also, the following example assumes that the location of the transmitter 108 is unknown relative to receiver 102, but that knowledge about the location information of transmitter 108 is desirable and to be determined. As such, even though receiver 102 receives a signal transmitted from transmitter 108, the direction from transmitter 108 to receiver 102 (the direction of propagation of the signal, the line-of-sight from receiver 102 to transmitter 108, or the shortest distance from receiver 102 to transmitter 108) is unknown. The following example also assumes that the repetition rate of the transmitted signal (e.g., the emitted frequency) from transmitter 108 is unknown and therefore that the absolute Doppler shift in the received signal at receiver 102 is unknown. In other examples, one or more of these unknowns may be known to some degree. For example, in some examples, the repetition rate of features in the transmitted signal may be known to some extent.

Transmitter 108 may be any type of transmitter, such as a radar, a hand-held radio, a broadcast antenna, and/or a mobile telephone. Receiver 102 may be any type of receiver, such as a radar, a hand-held radio, and/or a mobile telephone. In the below example, with reference to FIG. 1A and FIG. 1B, receiver 102 is onboard aircraft 112 and transmitter 108 is radar installation 118. As such, aircraft 112 is moving in a direction of motion relative to radar installation 118.

Process 400 begins with transmitter 108 transmitting a signal having one or more cyclic features. In the current example, radar installation 118 transmits a signal with a cyclic feature (see FIG. 1B) and the signal propagates from the radar installation 118 to aircraft 112 in the direction of propagation. Process 400 continues with the reception and/or detection of the signal (block 402) by receiver 102. For example, aircraft 112 carrying receiver 102 receives the signal from radar installation 118. In one implementation, the signal is sampled and information is stored in memory 260 for signal processing by signal processor 218 (e.g., at that time and/or at a future time). In another embodiment, the received signal is stored transiently for signal processing by signal processor 218.

One or more cyclic features may be detected in the received signal (block 404). For example, cyclic spectral detector 222 may detect a cyclic feature in the received signal. In one implementation, signal processor 218 retrieves the recorded information regarding the received signal from memory 260 for analysis. In one implementation, cyclic spectral detector 222 may generate a cyclic power spectral density, such as a shown in FIG. 3A and/or FIG. 3B as part of the process for detecting the cyclic feature. In the current example, aircraft 112 may detect the cyclic features of the signals emanating from the radar installation 118.

The repetition rate of the cyclic feature (block 406) of the received signal may be determined. Cyclic spectral detector 222 may determine the repetition rate of the cyclic feature. In one embodiment, the repetition rate of the cyclic feature may correspond to one axis of the cyclic power spectral density, as shown in FIG. 3A and/or FIG. 3B. The repetition rate of the received signal (e.g., the detected frequency) may be different than that of the transmitted signal (e.g., the emitted frequency) due to a Doppler shift, e.g., if receiver 102 is in motion relative to transmitter 108. In the current example, aircraft 112 is in motion relative to radar installation 118 and the received signal would experience a Doppler shift with respect to the cyclic feature. If the repetition rate of the transmitted signal is unknown, however, then the absolute Doppler shift may also be unknown. That is, because the location of transmitter 108 is not known, then the direction of the motion of receiver 102 relative to transmitter 108 is not known. Thus, even if the speed and direction of receiver 102 is known, the absolute Doppler shift (i.e., the difference between the transmitted repetition rate and the received repetition rate) may be unknown. In the current example, the speed and direction of aircraft 112 may be known relative to the earth but the location of radar installation 118 may not be known to aircraft 112.

The repetition rate of the cyclic feature may be determined (block 406) multiple times or on a continuous basis. Although the features of a cyclic signal may be transmitted at a constant rate, when receiver 102 is moving relative to transmitter 108, the timing between consecutive instances of the cyclic feature as received may not be constant (e.g., if there is a closing acceleration between receiver 102 and transmitter 108). That is, in instances in which the closing distance between transmitter 108 and receiver 102 is accelerating, the timing between consecutive instances of the cyclic features as received will increase or decrease with time even if the timing between features of the transmitted signal is constant. In other words, even in instances where receiver 102 is moving at a constant velocity in the reference fame of transmitter 108, the closing speed between receiver 102 and transmitter 108 maybe changing (e.g., a closing acceleration) unless receiver 102 is moving directly toward or away from transmitter 108 (e.g., toward or away from the direction of propagation).

Process 400 may determine the rate of change of the repetition rate of the received signal, which is termed the Doppler shift change rate (DSCR) (block 408). Any method of determining the Doppler shift change rate is possible. That is, because the repetition rate of the received signal is determined multiple times over a time span, DSCR detector 224 may determine the DSCR of the cyclic feature in the received signal. The time span may differ depending on the type of signal and the expected repetition rate. For example, acoustic signals (e.g., in the case of sonar) may be expected to have a different repetition rate than an electromagnetic signal (e.g., in the case of radar installation 118) and the time span may differ accordingly. Even though the absolute Doppler shift may be unknown (if the repetition rate of the transmitted signal is unknown), the change rate of the Doppler shift may be determinable. The DSCR may be determined over a short time span based on multiple determinations of the repetition rate in the short time span. In the current example, if aircraft 112 is flying in a direction not directly toward or away from radar installation 118 (e.g., toward or away from the direction of propagation of the signal from radar installation 118 to aircraft 112), but at deflection angle 156, then the signal will experience a Doppler shift change rate as it is received by aircraft 112 (because the closing speed between aircraft 112 and radar installation 118 is changing). As shown in FIG. 1B, aircraft 112 is flying in the direction of arrow 152-1 at time T1, which is at a deflection angle 156-1 away from the direction from aircraft 112 to radar installation 118.

If the timing between the consecutive instances of a cyclic feature is not constant in the received signal, the power density of the cyclic feature may be reduced (as compared to the received signal not having experienced a non-zero Doppler shift change rate). In other words, when a cyclic signal is subjected to a non-zero Doppler shift change rate, the timing between consecutive instances of a cyclic feature is no longer constant and consequently, the cyclic feature power density may be reduced. A zero Doppler shift change rate would imply that receiver 102 may either be stationary relative to transmitter 108 or that receiver 102 is moving at a constant velocity relative to transmitter 108 in the direction directly toward or directly away from transmitter 108 (e.g., in the line of propagation of the signal from radar installation 118 to aircraft 112). On the other hand, a non-zero Doppler shift change rate would imply that the closing speed between receiver 102 and transmitter 108 is changing (a closing acceleration). In other words, it implies that receiver 102 is moving relative to transmitter 108 but at an angle away from a direct line from transmitter 108 to receiver 102 (e.g., assuming that receiver 102 is moving at a constant velocity in the reference frame of transmitter 108). The direct line from transmitter 108 to receiver 102 is the direction of propagation of the signal from transmitter 108 to receiver 102.

In one embodiment, DSCR detector 224 may alter the received signal to reverse (e.g., through modeling to determine) the Doppler shift change rate. Reversing (or determining) the Doppler shift change rate may begin with the selection of possible change rates or a range of possible change rates. Selection may be based on real-world situations, such as whether transmitter 108 is known to be stationary relative to the earth, possible ranges of receiver 102 from transmitter 108, and/or the speed and direction of travel of receiver 102. The possible Doppler shift change rates may be a list of discrete rates or a range of possible rates. Reversing the Doppler shift change rate may result in numerous signals, one of which may be determined to be the signal having used the true Doppler shift change rate (e.g., the Doppler shift change rate determined to be the most likely). The “true DSCR” is the change rate that the transmitted signal experiences as a result of being received by receiver 102 moving in the reference frame of transmitter 108. The true recovered signal (the signal recovered after reversing the true Doppler shift change rate) represents what the received signal would look like with a Doppler shift, but without a Doppler shift change rate. In other words, the features in the recovered signal have the timing returned to a constant repetition rate.

In one embodiment, DSCR detector 224 may determine the true DSCR by searching for the Doppler shift change rate that maximizes the cyclic feature power density. DSCR detector 224 may analyze the cyclic feature power density (e.g., on each possible recovered signal corresponding to a different Doppler shift change rate) to find the recovered signal with the greatest cyclic feature power density. DSCR detector 224 may then determine that the true DSCR (e.g., most likely DSCR) is the DSCR that corresponds to the recovered signal with the greatest cyclic feature power density. DSCR detector 224 may determine the greatest cyclic power density based on the maximum of, the integral of, the average of, the mean square of the cyclic feature power density, and/or any other quantity which would tend to indicate a higher value of some or all of the cyclic feature power density. DSCR detector 224 may search for the true Doppler shift change rate using optimization techniques such as a Nelder-Mead search, a Newton's Method search, a randomized hill-climbing search, a genetic algorithm, or any other optimization or searching technique.

In another embodiment, the Doppler shift change rate may be determined (block 408) using a non-searching method (e.g., a closed-form solution), such as finding zeros of derivatives or any other closed-form technique. Such a closed form solution may provide for a rapid calculation of closing acceleration (block 410), deflection angle (block 412), and/or range (block 416).

If transmitter 108 is stationary in its own reference frame, and if receiver 102 is moving in the reference frame of transmitter 108, the closing acceleration is the time rate of change in the closing speed. In the current example, radar installation 118 is stationary in its own reference frame (and relative to the surface of the earth), and aircraft 112 is moving in the reference frame of radar installation 118 (and relative to the earth). Process 400 (e.g., location logic 226) may determine the closing acceleration (block 410). In one embodiment, the rate of change in the closing speed (the closing acceleration) may be determined by multiplying the signal speed by the relative Doppler shift change rate. That is, process 400 may determine the closing acceleration based on the Doppler shift change rate and the signal speed.

Process 400 (e.g., location logic 226) may continue with the determination of the angle of deflection (e.g., azimuth) (block 412). The angle of deflection may be defined in either two-dimensional or three-dimensional space. In two-dimensional space, the angle of deflection 156 to the emitter may be expressed as the azimuth to transmitter 108. In three-dimensional space, the angle of deflection 156 to the emitter may be expressed as the azimuth and elevation to transmitter 108. In one embodiment, the deflection angle may be determined based on the change rate of the Doppler shift of the cyclic feature.

In one embodiment, the closing speed between transmitter 108 and receiver 102 may be determined based on the speed of receiver 102 and the angle of deflection. For example, if the speed of receiver 102 is known in the reference frame of transmitter 108, then the closing speed between the transmitter 108 and receiver 102 may be determined by multiplying the speed of receiver 102 in that reference frame by the cosine of the angle of deflection. Taking the time derivative, the closing acceleration may be determined by multiplying the speed of receiver 102 in the reference frame of the transmitter 108 by the negative of the sine of the angle of deflection to transmitter 108. Therefore, if the speed of receiver 102 in the reference frame of the transmitter 108 and the closing acceleration between receiver 102 and transmitter 108 are known, it is possible to compute two values for the angle of deflection by dividing the closing acceleration by the closing speed, and then computing the negative of the arcsine of the result. There may be two values for the angle of deflection because there are two angles that result from the arcsine function. That is, the angle of deflection may be computed but with an ambiguity. The two possible angles are equal in magnitude, but one of them is to the right of the direction of motion (e.g., arrow 152-1) of receiver 102, and the other is to the left of the direction of motion (e.g., arrow 152-1) receiver 102. This may be referred to as a left-right ambiguity.

The angle of deflection (e.g., azimuth) may be determined (block 412) multiple times or on a continuous basis. That is, because the repetition rate of features in the received signal is determined multiple times over a time span, location logic 226 may determine the deflection angle multiple times. Accordingly, process 400 may determine the rate of change of the deflection angle (block 414) as well.

Process 400 may determine the range to the emitter (block 416). Location logic 226 may use the time rate of change in the azimuth from receiver 102 to transmitter 108 to compute the range to emitter. That is, additional measurements may provide results which may be statistically filtered for an increasingly precise result. Additional measurements by receiver 102 along a single direction of motion, for example, yields an angular deflection rate of change that may be determined by dividing the change in angular deflection by the time between the measurements. The units of the angular deflection rate of change can be radians per second (or degrees per second, or any other unit of angle per unit of time).

Process 400 may compute the range from receiver 102 to transmitter 108 as follows. In one embodiment, location logic 226 may determine a quantity by multiplying to the speed of receiver 102 with the angular deflection rate of change. Location logic 226 may then divide the quantity by 4 and then by the cosine of the angular deflection to radar installation 118. The result is the range from receiver 102 to transmitter 108. The value is unique; that is, there is no left-right ambiguity with respect to the range. With two possible angular deflections from receiver 102 to transmitter 108 and with a unique range between the two (and with known altitudes of receiver 102 and transmitter 108), there are two possible locations for the emitter relative to the detector. These two positions are symmetrically located to the left and the right of the path of motion of the detector. This is known as a left-right ambiguity in the location of the emitter.

Process 400 may resolve ambiguities (block 418). Location logic 226 may resolve any ambiguities (e.g., multiple solutions) to the range and/or azimuth to transmitter 108 with additional measurements. For example, the relative motion between receiver 102 and transmitter 108 may be changed by changing the direction of the motion of receiver 102 relative to transmitter 108. For example, as shown in FIG. 1B, at time T2 aircraft 112 may change direction according to arrow 152-2, thus creating a different deflection angle 156-2. With a different direction of motion, measurements at receiver 102 will determine another deflection angle with a left/right ambiguity. The two pairs of deflection angles should resolve each other's ambiguity because only one set of angles will generate intersecting lines from the receiver 102. That is, if receiver 102 changes its direction of motion, then performs an additional measurement and determination of deflection angle, then only one of the two ambiguities created in the new measurement will match either of the two ambiguities previously computed. Thus, the location of transmitter 108 may be determined uniquely (but may include uncertainty due to noise in observations and measurements). The use of several additional measurements, possibly utilizing a variety of directions of detector motion, can be combined to reduce uncertainty in the determination of location.

When transmitter 108 and receiver 102 are at known altitudes, the angle of deflection to the emitter, which is an angle away from the direction of motion of receiver 102, creates a cone of constant angular deflection around the direction of motion of receiver 102, which when intersected with the altitude plane of transmitter 108, creates a hyperbola or other linear curve within that plane, and only two points on that linear curve will have the range that has been computed. These two points may have a left-right ambiguity which can be resolved as described earlier. If the altitude of transmitter 108 and/or the receiver 102 are considered to be relative to a sphere or on an ellipsoid, then it is understood that the shape will be approximately hyperbolic, that left-right ambiguity may still exist, and may be resolved as described herein.

This example of a fixed transmitter 108 (radar installation 118) and a moving receiver 102 (aircraft 112) can be generalized with respect to frames of reference. That is, although the reference frame of transmitter 108 is described as stationary, it may in fact be in motion relative to another reference frame, such as the reference frame of the earth.

In one embodiment, multiple receivers 102 may be used. For example, the first DSCR may be determined at the first receiver 102 and the second DSCR may be determined at the second receiver 102-2. That is, two receivers 102 moving in different directions while observing the same transmitter 108 (even if each of the two receivers do not change direction) can be used together to determine two azimuths (i.e., from each receiver 102) to locate the transmitter using the two DSCRs. Using two receivers 102 in this example is analogous to using one receiver 102 and changing the direction of motion between determination of DSCR. For example, two satellites (which may not be able to maneuver) but are traveling in differently inclined orbits, observing the same emitter, may be able to locate the transmitter 108 unambiguously.

One example described above shows aircraft 112 with radar installation 118. In the example, aircraft 112 may include a single receiver 102 and determine location information such as deflection angle 156 and/or a range. Receiver 102 in aircraft 112 may receive signals from radar installation 118 over different periods of time from different locations and/or while traveling in different directions. In other examples, multiple receivers 102 may be used (e.g., in aircraft 112 or another object(s)) to determine location information for other types of transmitters 108. For example, receiver 102 in aircraft 112 may determine location information of a tank (e.g., having transmitter 108). Multiple receivers 102 may also be used in separate objects. For example, one or more (e.g, two) satellites 106 may each include a receiver 102 to detect and determine location information for aircraft 112 (e.g., having transmitter 108) or radar installation 118. One or more underwater sound detectors (e.g., two) may each include a microphone (e.g., receiver 102 being fixed and/or moving) that determine location information of a moving submarine (e.g., emitting sound). In this embodiment, information determined at each microphone (e.g., each receiver 102) may be used together (e.g., a first propagation direction and a second propagation direction at different or the same time) to determine location information.

Receiver 102 may include an omnidirectional antenna and/or a directional antenna. If a directional antenna (e.g., with one or more antenna elements), then methods and systems described herein may be used to determine additional location information (e.g., in addition to the direction of the antenna). Methods and systems described herein may be used in conjunction with other location determination methods and systems. Determining location information may include, for example, determining deflection angle (e.g., azimuth and/or elevation) and/or range.

As described above, any inertial reference frame of reference may be used and solutions in this reference frame apply equally well to solutions in any other inertial reference frame with appropriate modifications. Thus, where “the receiver is moving in a direction of motion relative to the transmitter,” includes the reference frame where the transmitter is stationary relative to the earth and the receiver is moving relative to the earth; or where the receiver is stationary relative to the earth and the transmitter is moving relative to the earth. In one embodiment, knowledge of the closing velocities (and/or closing accelerations) between the transmitter and receiver(s) may inform selection of possible Doppler shift change rates (for determining the true Doppler shift change rate) and/or for a closed form solution for the local Doppler shift change rate.

The foregoing description of implementations provides illustration and description, but is not intended to be exhaustive or to limit the invention to the precise form disclosed. Modifications and variations are possible in light of the above teachings or may be acquired from practice of the invention. For example, while a series of messages and/or blocks have been described with regard to FIG. 4, the order of the blocks and message/operation flows may be modified in other embodiments. Further, non-dependent blocks may be performed in parallel.

Certain features described above may be implemented as “logic,” a “unit,” or a “component” that performs one or more functions. This logic, unit, or component may include hardware, such as one or more processors, microprocessors, application specific integrated circuits, or field programmable gate arrays, software, or a combination of hardware and software.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Various embodiments have been described herein with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method comprising:
receiving a signal in a receiver from a transmitter
wherein the signal propagates from the transmitter to the receiver in a direction of propagation,
wherein the receiver is moving in a direction of motion relative to the transmitter, and
wherein the signal includes a cyclic feature;
determining a change rate of a Doppler shift of the cyclic feature in the received signal; and
determining, based on the change rate of the Doppler shift of the cyclic feature, an angle between the direction of motion of the receiver and the direction of propagation.

2. The method of claim 1, further comprising:
determining a closing acceleration between the transmitter and the receiver.

3. The method of claim 2, wherein determining the angle includes determining the angle based on the closing acceleration.

4. The method of claim 3, further comprising:
determining a rate of change of the angle between the direction of motion of the receiver and the direction of propagation.

5. The method of claim 4, further comprising:
determining a range from the receiver to the transmitter based on the rate of change of the angle.

6. The method of claim 1,
wherein determining the change rate of the Doppler shift of the cyclic feature in the received signal includes determining a cyclic power spectral density of the received signal.

7. The method of claim 1, the direction of propagation is a first direction of propagation, the change rate of a Doppler shift is a first change rate of the Doppler shift, and the angle is a first angle, the method further comprising:
receiving the signal, in the receiver from the transmitter wherein the signal propagates from the transmitter to the receiver in a second direction of propagation;
determining a second change rate of a Doppler shift of the cyclic feature in the received signal; and
determining, based on the second change rate of the Doppler shift, a second angle between a second direction of motion of the receiver and the direction of propagation.

8. A device comprising:
a receiver to receive a signal from a transmitter,
wherein the signal propagates from the transmitter to the receiver in a direction of propagation,
wherein the receiver is moving in a direction of motion relative to the transmitter, and
wherein the signal includes a cyclic feature;
a processor configured to:
determine a change rate of a Doppler shift of the cyclic feature in the received signal; and
determine, based on the change rate of the Doppler shift of the cyclic feature, an angle between the direction of motion of the receiver and the direction of propagation.

9. The device of claim 8, wherein the processor is further configured to determine a closing acceleration between the transmitter and the receiver.

10. The device of claim 9, wherein the processor is further configured to determine the angle based on the closing acceleration.

11. The device of claim 10, wherein the processor is further configured to determine a rate of change of the angle between the direction of motion of the receiver and the direction of propagation.

12. The device of claim 11, wherein the processor is further configured to determine a range from the receiver to the transmitter based on the rate of change of the angle.

13. The device of claim 8, wherein the processor is further configured to determine a cyclic power spectral density of the received signal when determining the change rate of the Doppler shift of the cyclic feature in the received signal.

14. The device of claim 8,
wherein the direction of propagation is a first direction of propagation, the change rate of a Doppler shift is a first change rate of the Doppler shift, and the angle is a first angle,
wherein the receiver is configured to receive the signal from the transmitter wherein the signal propagates from the transmitter to the receiver in a second direction of propagation,
wherein the processor is further configured to determine a second change rate of a Doppler shift of the cyclic feature in the received signal and determine, based on the second change rate of the Doppler shift, a second angle between a second direction of motion of the receiver and the direction of propagation.

15. A a non-transitory computer-readable storage medium containing computer program code, the computer program code, when executed by one or more processors, causes the one or more processors to perform operations, the computer program code comprising instructions to:
receive data indicative of a signal having been received from a transmitter,
wherein the signal propagated from the transmitter to the receiver in a direction of propagation,
wherein the receiver is moving in a direction of motion relative to the transmitter, and
wherein the signal includes a cyclic feature;
determine a change rate of a Doppler shift of the cyclic feature in the signal; and
determine, based on the change rate of the Doppler shift of the cyclic feature, an angle between the direction of motion of the receiver and the direction of propagation.

16. The computer-readable storage medium of claim 15, wherein the computer program code further includes instructions to:
determine a closing acceleration between the transmitter and the receiver.

17. The computer-readable storage medium of claim 16, wherein the computer program code further includes instructions to determine the angle includes determining the angle based on the closing acceleration.

18. The computer-readable storage medium of claim 17, wherein the computer program code further includes instructions to determine a rate of change of the angle between the direction of motion of the receiver and the direction of propagation.

19. The computer-readable storage medium of claim 17, wherein the computer program code further includes instructions to determine a range from the receiver to the transmitter based on the rate of change of the angle.

20. The computer-readable storage medium of claim 15,
wherein determining the change rate of the Doppler shift of the cyclic feature in the received signal includes determining a cyclic power spectral density of the received signal;
wherein the direction of propagation is a first direction of propagation, the change rate of a Doppler shift is a first change rate of the Doppler shift, and the angle is a first angle,
wherein the computer program code further includes instructions to:
receive the signal, in the receiver from the transmitter wherein the signal propagates from the transmitter to the receiver in a second direction of propagation;
determine a second change rate of a Doppler shift of the cyclic feature in the received signal; and
determine, based on the second change rate of the Doppler shift, a second angle between a second direction of motion of the receiver and the direction of propagation.
